(19) United States
(12) Patent Application Publication
(10) Pub. No.: US 2026/0085009 A1
(43) Pub. Date: Mar. 26, 2026

(54) METAKAOLIN CONCRETE AND PROCESSES FOR PREPARING SAME

(71) Applicant: Gerry DAALDER, Kanata (CA)

(72) Inventor: Gerry DAALDER, Kanata (CA)

(21) Appl. No.: 19/220,672

(22) Filed: May 28, 2025

Related U.S. Application Data
(60) Provisional application No. 63/652,331, filed on May 28, 2024.

(51) Int. Cl. C04B 28/00; C04B 18/08; C04B 18/10; C04B 18/12; C04B 18/14; C04B 22/06

(52) U.S. Cl. CPC C04B 28/006; C04B 18/08; C04B 18/101; C04B 18/12; C04B 18/141; C04B 18/146; C04B 22/062

(57) ABSTRACT

The present invention provides a metakaolin concrete formulation comprising metakaolin, a coarse and fine aggregates, and an alkaline activator solution comprising a mixture of an aqueous hydroxide solution and an aqueous silicate solution. The formulation, in one embodiment, also includes a proportion of a waste byproduct. Also disclosed are processes for preparing a concrete product using the metakaolin concrete formulation.

### FIELD OF THE INVENTION

The present invention pertains to the field of concrete production and in particular to concrete formulations having a reduced environmental footprint.

### BACKGROUND

Cement production is a thermal energy intensive process, which requires heating solid particles up to 1450° C. and cooling it down. The process generates hot and CO₂ rich exhaust streams and high demand for energy. The greenhouse gas emission due to cement production is estimated to be around 6%-8% of the total global emissions. Due to the increasing prices of cement and its harmful effect on the environment, the use of cement has become highly unsustainable in concrete production. There is therefore a considerable need for promoting the use of cement replacement materials.

Metakaolin (MK) has significant potential in the development of concrete composites. Metakaolin is an anhydrous calcined form of the clay mineral kaolinite (also called kaolin) and is a highly reactive pozzolanic material. It is produced after appropriate heat treatment of kaolin, the main source of metakaolin. Metakaolin is commonly used in the production of ceramics, but has also been used as cement replacement in concrete, with typical replacement levels in the range of from 5% to 10%. Metakaolin has a smaller particle size (˜1-2 μm) and higher surface area compared with Portland cement.

One of the sustainable aspects of using metakaolin in concrete production is its manufacturing temperature. Compared to cement production of about 1500° C., metakaolin is burned at lower temperature at about 700-900° C., thus being a less energy intensive process.

When used in concrete, metakaolin undergoes a pozzolanic reaction and refines the microstructure of the hydrated cement paste. Due to the small particle size and high surface area, metakaolin reacts quickly and reduces the diffusion coefficient compared with plain Portland cement.

Concrete production also generates a high demand for aggregate materials such as sand. The depletion of natural sand has led to environmental consequences such as flooding in many parts of the world. It is anticipated that by 2050 concrete production will reach four times the level as that of 1990. There is therefore also a need to develop aggregate alternatives having a smaller environmental footprint.

Therefore there is a need for processes for producing concrete which minimize the amount of Portland cement and conventional aggregates used without sacrificing the quality of the final product.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a metakaolin concrete and processes for preparing same. In accordance with an aspect of the present invention, there is provided a metakaolin concrete formulation comprising metakaolin, a coarse aggregate, a fine aggregate, and an alkaline activator solution comprising a mixture of an aqueous hydroxide solution and an aqueous silicate solution. The formulation also includes water in an amount sufficient to provide a workable wet concrete product.

In accordance with another aspect of the present invention, there is provided a process for preparing a metakaolin concrete product comprising the steps of: combining and mixing metakaolin, coarse aggregate, fine aggregate and optional waste byproduct to provide an evenly distributed metakaolin mixture; adding an alkaline activator solution to the metakaolin mixture under continuous mixing to provide an activated metakaolin mixture; and adding water to the activated metakaolin mixture to provide a wet concrete mixture of the desired consistency.

### DETAILED DESCRIPTION OF THE INVENTION The present invention provides a metakaolin concrete formulation comprising metakaolin.

The term “metakaolin” is used to refer to the anhydrous calcined form of the clay mineral kaolinite.

The term “coarse aggregate” is used to define any particles greater than about 0.5 cm (0.19 inch), but generally range between about 1 cm (⅜ inch) to 4 cm (1.5 inch) in diameter. Examples of coarse aggregates used in concrete production include gravels and crushed stone.

The term “fine aggregate” is used to define particles which can be passed through a number 4 sieve, with a mesh size of 4.75 mm. Examples of fine aggregates may include things such as sand, silt and clay.

The aggregates may be obtained from natural sources, such as digging or dredging from a pit, river, lake, or seabed. They may also be produced by crushing quarry rock, boulders, cobbles, large-size gravel, or recycled concrete.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

### FORMULATION

In accordance with the present invention, the concrete formulation is prepared using metakaolin instead of cementitious powder (Portland cement) in combination with both coarse and fine aggregates. Metakaolin has a very low carbon footprint and provides a high strength concrete product with a very short curing time.

In one embodiment of the concrete formulation, a proportion of the coarse and/or fine aggregates is replaced or supplemented with one or more byproducts of waste and commercial processes.

The use of the waste byproducts provides a concrete product having a reduced environmental footprint. The use of waste byproducts that have high dumping fees, or are otherwise difficult to dispose of, may reduce even further the environmental footprint of the final concrete formulation as well as diverting waste from landfills.

The higher concrete strength achieved by the use of metakaolin may allow for the elimination of up to 20% of the aggregates relative to conventional concrete formulations, thus leading to a lighter final concrete product.

The metakaolin concrete product of the present invention also has increased resistance to salt and acid, leading to concrete structures with longer lifespans than that achieved with conventional concrete formulations.

In one embodiment, the metakaolin concrete formulation comprises metakaolin, a coarse aggregate, a fine aggregate, and an alkaline activator solution comprising a mixture of an aqueous hydroxide solution and an aqueous silicate solution. The formulation also includes water in an amount sufficient to provide a workable wet concrete product. In one embodiment, the formulation also includes a proportion of a waste byproduct.

In one embodiment, the formulation comprises metakaolin in an amount of about 4 to about 8 parts by weight. In one embodiment, the formulation comprises metakaolin in an amount of about 5 to about 7 parts by weight.

In one embodiment, the formulation comprises coarse aggregate in an amount of about 9 to about 13 parts by weight. In one embodiment, the formulation comprises coarse aggregate in an amount of about 10 to about 12 parts by weight.

In one embodiment, the formulation comprises fine aggregate in an amount of about 4 to about 7 parts by weight. In one embodiment, the formulation comprises fine aggregate in an amount of about 5 to about 6 parts by weight.

In one embodiment, the formulation comprises waste byproduct in an amount of from about 0.2 to about 5 parts by weight. In one embodiment, the formulation comprises waste byproduct in an amount of from about 0.5 to about 4.5 parts by weight of a waste byproduct.

In one embodiment, the waste byproduct is selected from biomass ash, lithium processing byproduct waste, silica fume, fly ash, powdered slag, and any combination thereof.

In one embodiment, the formulation comprises about 3 to about 8 parts by weight of an alkaline activator solution comprising a mixture of an aqueous hydroxide solution and an aqueous silicate solution. In one embodiment, the formulation comprises about 3.5 to about 7.5 parts by weight of an alkaline activator solution comprising a mixture of an aqueous 10% (m/v) to 15% (m/v) hydroxide solution and an aqueous 1.5M-2.5 M silicate solution.

In one embodiment, the concrete formulation comprises about 0.5 to about 3 parts by weight of the aqueous hydroxide solution and about 2 to about 5 parts by weight of the aqueous silicate solution.

In one embodiment, the hydroxide solution employed in the activator solution comprises potassium hydroxide, sodium hydroxide or a combination thereof. In one embodiment, the aqueous hydroxide solution is a 14% (m/v) aqueous hydroxide solution.

In one embodiment, the silicate solution employed in the activator solution comprises sodium silicate, potassium silicate, lithium silicate, or any combination thereof. In one embodiment, the aqueous silicate solution is a 2 M aqueous silicate solution.

### Process for Preparing a Metakaolin Concrete Product

The present invention also provides processes for preparing a concrete product using the metakaolin formulations.

In one embodiment, the process for preparing a metakaolin concrete product comprises the steps of: combining and mixing metakaolin, coarse aggregate, fine aggregate and optional waste byproduct to provide an evenly distributed metakaolin mixture. An alkaline activator solution is added to the metakaolin mixture under continuous mixing to provide an activated metakaolin mixture. Water is then added to the activated metakaolin mixture to provide a wet concrete mixture of the desired consistency. Once the desired consistency has been achieved, the wet concrete mixture is placed in a formwork and compacted. The wet concrete is then cured under suitable temperature and humidity conditions for a time sufficient to form a solid metakaolin concrete product.

The invention will now be described with reference to specific examples. It will be understood that the following examples are intended to describe embodiments of the invention and are not intended to limit the invention in any way.

### EXAMPLES

### Example A

### Process for Preparing Metakaolin Concrete

The following is a general process for preparing a metakaolin concrete product.

Metakaolin: Provide metakaolin in a dry state.

Aggregates: Combine coarse and fine aggregates in the desired proportions (e.g., 2:1 coarse aggregate: fine aggregate) to achieve the desired workability and strength and mix with the metakaolin.

Alkaline Activator Solution: Prepare the alkaline activator solution by mixing Sodium hydroxide/Potassium Hydroxide and Sodium silicate/Potassium silicate/Lithium silicate solutions in the specified proportions.

Mixing: Gradually add the alkaline activator solution to the dry mixture of metakaolin and aggregates while continuously mixing. Adjust the water content as needed to achieve the desired consistency and workability.

Quality Control: Conduct slump tests and other quality control measures to ensure that the fresh concrete meets the specified requirements for workability.

Placing and Compacting: Place the freshly mixed concrete into the formwork and compact it thoroughly using vibration or other appropriate methods to ensure proper consolidation and density.

Curing: Steam cure or thermal cure the geopolymer concrete specimens under controlled conditions, maintaining a consistent temperature (e.g., 60-80° C.) and humidity for the specified curing duration (e.g., 24-48 hours).

Testing: After the curing period, conduct compressive strength tests on the hardened concrete specimens to verify that the desired strength of 110 MPa is achieved.

### Example B

### Process for Preparing Metakaolin Concrete Incorporating Waste Byproduct

The following is a general process for preparing metakaolin concrete products incorporating different waste byproducts.

Metakaolin and Byproducts: Mix metakaolin and the waste byproducts together in a dry state to ensure uniform distribution of the pozzolanic materials.

Aggregates: Combine coarse and fine aggregates in the desired proportions (e.g., 2:1 coarse aggregate: fine aggregate) to achieve the desired workability and strength and mix with the metakaolin/waste byproduct mixture.

Alkaline Activator Solution: Prepare the alkaline activator solution by mixing Sodium hydroxide/Potassium Hydroxide and Sodium silicate/Potassium silicate/Lithium silicate solutions in the specified proportions.

Mixing: Gradually add the alkaline activator solution to the dry mixture of metakaolin, waste byproducts, and aggregates while continuously mixing. Adjust the water content as needed to achieve the desired consistency and workability.

Quality Control: Conduct slump tests and other quality control measures to ensure that the fresh concrete meets the specified requirements for workability.

Placing and Compacting: Place the freshly mixed concrete into the formwork and compact it thoroughly using vibration or other appropriate methods to ensure proper consolidation and density.

Curing: Steam cure or thermal cure the geopolymer concrete specimens under controlled conditions, maintaining a consistent temperature (e.g., 60-80° C.) and humidity for the specified curing duration (e.g., 24-48 hours).

Testing: After the curing period, conduct compressive strength tests on the hardened concrete specimens to verify that the desired strength of 110 MPa is achieved.

### Example C

### Metakaolin Concrete Formulations

Metakaolin Concrete Formulation (without Waste Byproduct)

The following is an exemplary metakaolin concrete formulation which includes no waste byproduct:
Metakaolin: 500 to 700 kg
Coarse aggregate (e.g., crushed stone or gravel): 1100 kg
Fine aggregate (e.g., sand): 550 kg
Alkaline activator solution:
   Sodium hydroxide/Potassium Hydroxide solution (14% concentration): 90 to 270 kg
   Sodium silicate/Potassium silicate/Lithium silicate (water glass) solution (2.0M): 270 to 450 kg
Water as needed for workability.

The components outlined above are combined according to the process described in Example A to provide the final metakaolin concrete product.

### Metakaolin+Silica Fume Concrete Formulation

The following is an exemplary metakaolin concrete formulation which includes silica fume as an ingredient:
Metakaolin: 500 to 700 kg
Silica fume: 50 to 150 kg
Coarse aggregate (e.g., crushed stone or gravel): 1100 kg
Fine aggregate (e.g., sand): 550 kg
Alkaline activator solution:
   Sodium hydroxide/Potassium Hydroxide solution (14% (m/v) concentration): 90 to 270 kg
   Sodium silicate/Potassium silicate/Lithium silicate (water glass) solution (2.0M): 270 to 450 kg
Water as needed for workability.

The components outlined above are combined according to the process described in Example B to provide the final metakaolin+silica fume concrete product.

### Metakaolin+Lithium Waste/biomass Ash Byproduct Concrete Formulation

The following is an exemplary metakaolin concrete formulation which includes lithium wastes as ingredients:
Metakaolin: 500 to 700 kg
Biomass Ash byproduct: 50 to 150 kg
1^{st} stage of lithium byproduct (mine tailings): 50 to 150 kg
2^{nd} stage of lithium processing byproduct (product remaining after lithium extraction processes): 50 to 150 kg
Coarse aggregate (e.g., crushed stone or gravel): 1100 kg
Fine aggregate (e.g., sand): 550 kg
Alkaline activator solution:
   Sodium hydroxide/Potassium Hydroxide solution (14% (m/v) concentration): 90 to 270 kg
   Sodium silicate/Potassium silicate/Lithium silicate (water glass) solution (2.0M): 270 to 450 kg
Water as needed for workability.

The components outlined above are combined according to the process described in Example B to provide the final metakaolin+lithium waste concrete product.

### Metakaolin+Fly Ash Concrete Formulation

The following is an exemplary metakaolin concrete formulation which includes fly ask as an ingredient:
Metakaolin: 500 to 700 kg
Fly ash: 50 to 150 kg
Coarse aggregate (e.g., crushed stone or gravel): 1100 kg
Fine aggregate (e.g., sand): 550 kg
Alkaline activator solution:
   Sodium hydroxide/Potassium Hydroxide solution (14% (m/v) concentration): 90 to 270 kg
   Sodium silicate/Potassium silicate/Lithium silicate (water glass) solution (2.0M): 270 to 450 kg
Water as needed for workability.

The components outlined above are combined according to the process described in Example B to provide the final metakaolin+fly ash concrete product.

### Metakaolin+Slag Concrete Formulation

The following is an exemplary metakaolin concrete formulation which includes slag waste as an ingredient:
Metakaolin: 500 to 700 kg
Powdered slag: 50 to 150 kg
Coarse aggregate (e.g., crushed stone or gravel): 1100 kg
Fine aggregate (e.g., sand): 550 kg
Alkaline activator solution:
   Sodium hydroxide/Potassium Hydroxide solution (14% (m/v) concentration): 90 to 270 kg
   Sodium silicate/Potassium silicate/Lithium silicate (water glass) solution (2.0M): 270 to 450 kg
Water as needed for workability.

The components outlined above are combined according to the process described in Example B to provide the final concrete product.

All metakaolin concrete samples prepared using the formulations and processes described above exhibited compressive strength values of at least 50 MPa as measured at 4 hours post pouring, as compared to compressive strength values of 25 to 30 MPa at 28 days post pouring for conventional concrete formulations.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A metakaolin concrete formulation comprising:
about 4 to about 8 parts by weight metakaolin;
about 9 to about 13 parts by weight of a coarse aggregate;
about 4 to about 7 parts by weight of a fine aggregate; and
about 3 to about 8 parts by weight of an alkaline activator solution comprising a mixture of an aqueous 10% (m/v) to 15% (m/v) hydroxide solution and an aqueous 1.5M-2.5 M silicate solution.

2. The concrete formulation of claim 1, further comprising about 0.2 to about 5 parts by weight of a waste byproduct selected from biomass ash, lithium processing byproduct waste, silica fume, fly ash, powdered slag, and any combination thereof.

3. The concrete formulation of claim 1, wherein concrete formulation comprises about 0.5 to about 3 parts by weight of the aqueous hydroxide solution and about 2 to about 5 parts by weight of the aqueous silicate solution.

4. The concrete formulation of claim 3, wherein the aqueous hydroxide solution comprises potassium hydroxide, sodium hydroxide or a combination thereof.

5. The concrete formulation of claim 4, wherein the aqueous hydroxide solution is a 14% (m/v) aqueous hydroxide solution.

6. The concrete formulation of claim 3, wherein the aqueous silicate solution comprises sodium silicate, potassium silicate, lithium silicate, or any combination thereof.

7. The concrete formulation of claim 6, wherein the aqueous silicate solution is a 2 M aqueous silicate solution.

8. The concrete formulation of claim 1, further comprising water in an amount sufficient to provide a workable wet concrete product.

9. The concrete formulation of claim 2, comprising:
about 5 to about 7 parts by weight of the metakaolin;
about 10 to about 12 parts by weight of the coarse aggregate;
about 5 to about 6 parts by weight of the fine aggregate;
about 3.5 to about 7.5 parts by weight of the alkaline activator solution; and
about 0.5 to about 4.5 parts by weight of the waste byproduct.

10. The concrete formulation of claim 9, wherein the concrete formulation comprises about 0.5 to about 3 parts by weight of the aqueous hydroxide solution and about 2 to about 5 parts by weight of the aqueous silicate solution.

11. The concrete formulation of claim 10, wherein the aqueous hydroxide solution comprises potassium hydroxide, sodium hydroxide or a combination thereof.

12. The concrete formulation of claim 11, wherein the aqueous hydroxide solution is a 14% (m/v) aqueous hydroxide solution.

13. The concrete formulation of claim 10, wherein the aqueous silicate solution comprises sodium silicate, potassium silicate, lithium silicate, or any combination thereof.

14. The concrete formulation of claim 13, wherein the aqueous silicate solution is a 2 M aqueous silicate solution.

15. The concrete formulation of claim 9, further comprising water in an amount sufficient to provide a workable wet concrete product.

16. A process for preparing a metakaolin concrete product comprising the steps of:
combining and mixing metakaolin, coarse aggregate, fine aggregate and optional waste byproduct to provide an evenly distributed metakaolin mixture;
adding an alkaline activator solution to the metakaolin mixture under continuous mixing to provide an activated metakaolin mixture; and
adding water to the activated metakaolin mixture to provide a wet concrete mixture of the desired consistency.

17. The process of claim 16, further comprising the steps of:
placing and compacting the wet concrete mixture in a formwork; and
curing the wet concrete under suitable temperature and humidity conditions for a time sufficient to form a solid metakaolin concrete product.
